(19) United States
(12) Patent Application Publication
(10) Pub. No.: US 2012/0109835 A1
(43) Pub. Date: May 3, 2012

(54) USER FILTERING IN SOCIAL NETWORKING APPLICATIONS

(75) Inventors: Christopher B. Barefoot, Durham, NC (US); Tyler I. Carper, Research Triangle Park, NC (US); David D. Dukro, Research Triangle Park, NC (US); Kevin N. Magill, Research Triangle Park, NC (US); Michael S. O'Leary, Research Triangle Park, NC (US); M. Scott Thomason, Durham, NC (US)

(73) Assignee: INTERNATIONAL BUSINESS MACHINES CORPORATION, Armonk, NY (US)

(21) Appl. No.: 12/914,826

(22) Filed: Oct. 28, 2010

(51) Int. Cl. G06Q 99/00

(52) U.S. Cl. 705/319

(57) ABSTRACT

An apparatus, system, and method are disclosed for filtering third-party generated content in a social network. The method may involve receiving a request to view third-party generated content in a social network. The method may involve determining the group permissions that are set by the user for one or more groups. The user may define group membership. The group permissions define the access privileges to the third-party generated content. The method may also involve filtering the third-party generated content according to the group permissions such that the third-party generated content is filtered prior to its presentation to the requesting third-party user. As a result, certain third-party generated content may be hidden from certain third-party users. In certain embodiments, the user can set individual permissions governing access to the third-party generated content. In addition, filtering of third-party generated content may involve precedence of individual permissions over group permissions and precedence of the most restrictive group permissions when the requesting third-party is a member of numerous groups.

### FIELD

The subject matter disclosed herein relates to filtering user content in social networking applications.

### BACKGROUND

### Description of the Related Art

Social networks (also commonly referred to as social network services) have become increasingly popular in the past decade. Social networks are online services, platforms, or sites that focus on building and reflecting social connections among the social networks' users. Most social networks are web based and provide means for users to share information. Well-known examples of social networks include Facebook®, MySpace®, and LinkedIn®. Many other social networks are also in use across the world.

With increasing participation in social networks comes increasing concerns over privacy and safety. Many social networks provide users with some control over content about them on the social network. However, that control is limited. For example, a typical control allows a user to designate individuals who are allowed to view content which that user generates and puts on the social network. For example, a user may identify “friends” on the social network who can see the content which the user generates. Others who are not “friends” cannot view the content.

However, this may not provide adequate privacy or protection of a user's content, and also does not provide the user with the ability to define visibility relationships between other authorized third-party users of the content. For example, a user may post a comment to another user's homepage; that comment will be viewable by all persons who have authority to view the homepage, which the user who generated the content does not control. Similarly, a user may be identified in a photograph taken by another person and loaded onto the social network. The photograph may be visible to the friends of the person who loaded the photograph, regardless of whether or not the user wishes to be identified.

In view of the increasing concerns users have about controlling content they place on social networks, and in controlling content about them that is placed by others on social networks, a new privacy model would be beneficial.

### BRIEF SUMMARY

A computer program product may be configured to filter third-party generated content in a social network. The computer program product may be configured to receive, from a requesting third-party user, a request to view third-party generated content that is generated by third-party users of a social network. The computer program product may also be configured to determine one or more group permissions set by a user for the groups, the group permissions defining access to the third-party generated content. The approach may also involve filtering the third-party generated content according to the group permissions such that the third-party generated content is filtered prior to presentation of the third-party generated content to the requesting third-party user.

The computer program product may also be configured to determine one or more individual permissions defining access to the third-party generated content. The individual permissions may be set for the requesting third-party user by the user. The third-party generated content may be filtered according to the group permissions and the individual permissions. In certain embodiments, filtering may require determining the precedence of the group permissions and the individual permissions; the individual permissions may take precedence over the group permissions.

Filtering the third-party generated content according to the group permissions may involve applying a most restrictive set of group permissions if the requesting third-party user is a member of numerous groups. The group permissions may include, for example, a first rule that specifies the entities with access to the third-party generated content created by third-party users who are members of the first group; and a second rule specifying the entities that do not have access to the third-party generated content created by third-party users who are members of the first group. The requesting third-party user may be given access to third-party generated content created by third-party users who are members of the groups to which the requesting third-party user belongs. This filtering may be hidden from the requesting third-party user, such that the requesting third-party user is unaware that any third-party generated content is being filtered.

In certain embodiments, the invention may be realized as an apparatus. The apparatus may comprise a receive module that receives, from a requesting third-party user, a request to view third-party generated content that is generated by third party users of the social network. A group module may determine one or more group permissions set by a user for groups associated with the request. The group permissions may define access to the third-party generated content. The apparatus may also include a filter module that filters the third-party generated content according to the group permissions such that the third-party generated content is filtered prior to presentation of the third-party generated content to the requesting third-party user.

The apparatus may also include an individual module that determines individual permissions that define access to third-party generated content. The individual permissions may be set for the requesting third-party user by the user. In such embodiments, the filter module may filter the third-party generated content according to the group permissions and the individual permissions. The individual permissions may be given precedence over group permissions when they conflict. Where multiple group permissions apply, the filter module may apply a most restrictive set of group permissions. In certain embodiments, the apparatus is implemented on a server, and the third-party user sends the requests from a client communicatively connected to the server.

The invention may be realized as a method. The method may involve receiving, from a requesting third-party user, a request to view third-party generated content that is generated by third-party users of a social network. The method may also involve determining group permissions set by a user for groups. The method may also involve filtering the third-party generated content according to the group permissions such that the third-party generated content is filtered prior to presentation of the third-party generated content to the requesting third-party user.

In certain embodiments, the method involves determining individual permissions defining access to the third-party generated content and filtering the third-party generated content according to the group permissions and the individual permissions. As above, filtering the third-party generated content involves determining a precedence of group permissions and individual permissions and applying a most restrictive set of group permissions when the requesting third-party user belongs to a plurality of groups. The requesting third-party user may be given access to the third-party generated content created by third-party users within each group of which the requesting third-party user is a member. In certain embodiments, the filtering may be hidden from the requesting third-party user.

The invention may involve a method for setting filters for third-party generated content in a social network. The method may involve assigning third-party users of a social network to one or more groups and assigning group permissions for the groups. The method may also involve assigning individual permissions for the third-party users.

References throughout this specification to features, advantages, or similar language do not imply that all of the features and advantages may be realized in any single embodiment. Rather, language referring to the features and advantages is understood to mean that a specific feature, advantage, or characteristic is included in at least one embodiment. Thus, discussion of the features and advantages, and similar language, throughout this specification may, but do not necessarily, refer to the same embodiment.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a social network;

FIG. 2 is a schematic block diagram illustrating one embodiment of a system in which a filtering apparatus may be implemented with a social network;

FIG. 3 is a schematic block diagram illustrating one embodiment of a filtering apparatus filtering third-party generated content in a social network;

FIG. 4 is a schematic block diagram illustrating one embodiment of a filtering apparatus;

FIG. 5 is a schematic block diagram illustrating a second embodiment of a filtering apparatus;

FIG. 6 is a schematic block diagram illustrating a set of groups and associated group permissions;

FIG. 7 is a schematic diagram illustrating one embodiment of an interface for setting group permissions;

FIG. 8 is a schematic diagram illustrating one embodiment of an interface for setting individual permissions;

FIG. 9 is a schematic diagram illustrating one embodiment of an interface for making group assignments;

FIG. 10 is a schematic flow chart diagram illustrating one embodiment of a method for filtering third-party generated content; and

FIG. 11 is a schematic flow chart diagram illustrating one embodiment of a method for configuring appropriate group and individual permissions.

### DETAILED DESCRIPTION

As will be appreciated by one skilled in the art, aspects of the present invention may be embodied as a system, method, computer program product, or other embodiment. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of computer readable program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of computer readable program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable medium(s).

Any combination of one or more computer readable medium(s) may be utilized. The computer readable medium may be a computer readable signal medium or a computer readable storage medium. The computer readable medium may be a tangible computer readable storage medium storing the computer readable code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Computer readable program code embodied on a computer readable medium may be transmitted using any appropriate medium, including but not limited to wireless, wireline, optical fiber cable, RF, etc., or any suitable combination of the foregoing.

Computer readable program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The computer readable program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise. The term “may” is used in the permissive sense, indicating possible activities and/or arrangements, and not in its restrictive sense.

Furthermore, the described features, structures, or characteristics of the embodiments of the invention may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by computer readable program code. These computer readable program code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The computer readable program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer readable program code may also be loaded onto a computer, other programmable data processing apparatus, or other devices to cause a series of operational steps to be performed on the computer, other programmable apparatus or other devices to produce a computer implemented process such that the program code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer readable program code.

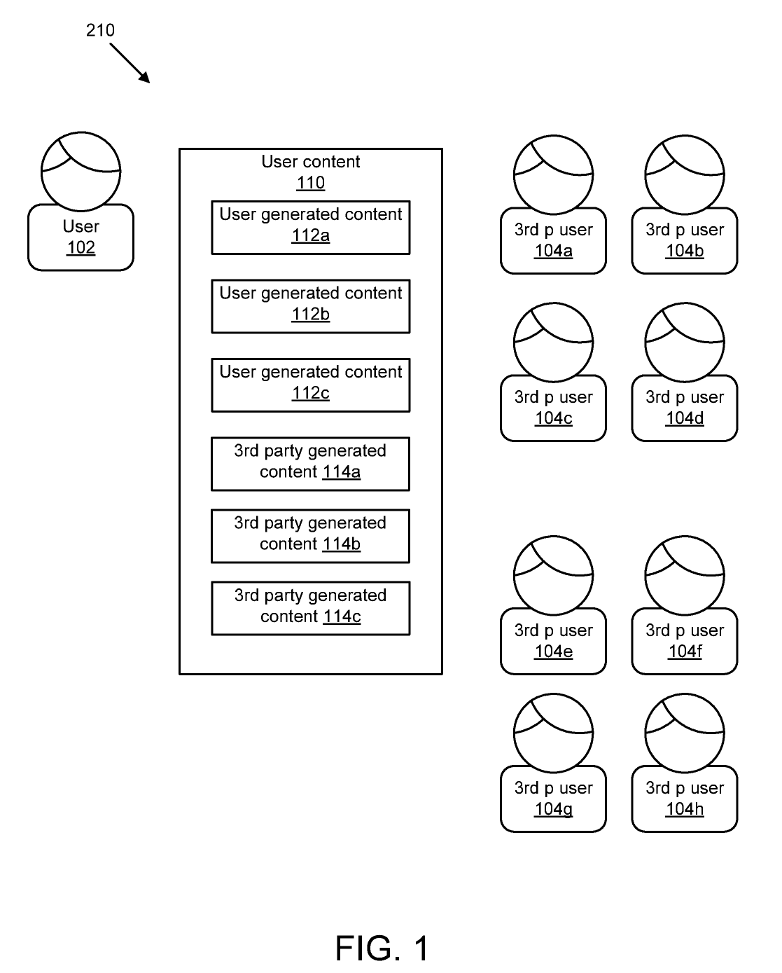

FIG. 1 depicts one embodiment of a social network. The social network 210 may include a user 102 and third-party users 104a-h. User 102 and the third-party users 104a-h are participants in a social network 210, and generate user content 110. The user content 110 is content in the social network 210 that is associated with user 102. User content 110 may include, for example, text, audio, video, images, or other media. Common examples of user content 110 in a social network 210 include posts on user 102's “wall,” photos, comments on photos, hyperlinks, and other varieties of content. The user content 110 may be associated with user 102 in a variety of ways; the user content 110 may be directed to user 102 (for example, the user content 110 may be posted on user 102's wall, or the user content 110 may be sent to the user 102 through a mail feature, the user content 110 may be in response to the user 102 creating user content 110, etc); the user content 110 may be created by the user 102; the user content 110 may be related to user 102 (for example, the user content 110 may be a photo of the user 102). The above are simply examples of how user content 110 may be associated with user 102. Associations other than those given above by way of example are also within the scope of this invention.

User content 110 includes user generated content 112a-c and third-party generated content 114a-c. User generated content 112a-c is user content 110 that is generated by the user 102. User generated content 112a-c may include, for example, status updates, photos, comments, links and other content that is introduced to the social network 210 by the user 102. Third-party generated content 114a-c is user content 110 that is generated by third-party users 104a-h and that is associated with the user 102. Third-party generated content 114a-c may include, for example, status updates, photos, comments, links and other content that is introduced to the social network 210 by the third-party users 104a-h.

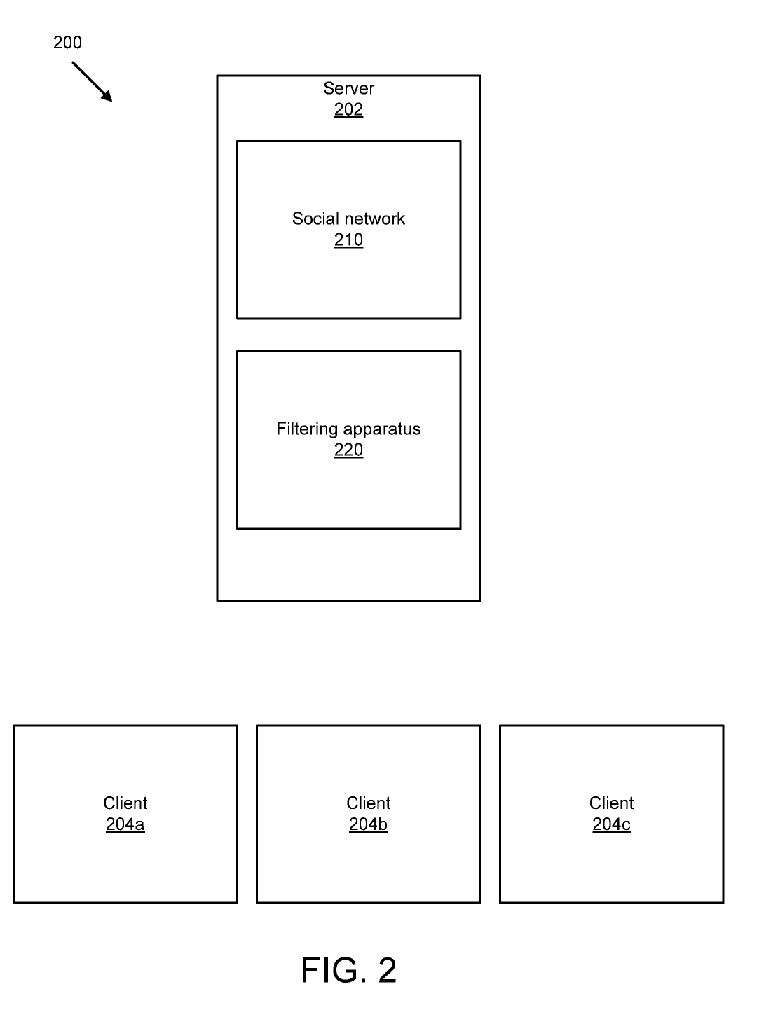

FIG. 2 shows one embodiment of a system 200 for filtering third-party generated content 114. The system 200 may include a server 202 and clients 204a-c. The clients 204a-c and server 202 may communicate information over a network such as a local area network (“LAN”), wide area network (“WAN”), wireless local area network or other network. In one embodiment, the server 202 and the clients 204a-c may communicate over the Internet. The clients 204a-c may be computing devices such as laptops, mobile phones, desktop computers, tablets, or other variety of computing device capable of communicating and receiving data over a network. The third-party users 104 and the user 102 may upload and download user content 110 using the clients 204a-c.

The server 202 may be any variety of computing devices executing software for sharing data over a network. The server 202 may include multiple physical computing devices. In one embodiment, the server 202 implements a social network 210 and the filtering apparatus 220. The social network 210 comprises the software necessary to implement a social network 210. The filtering apparatus 220 filters third-party generated content 114 in the social network 210.

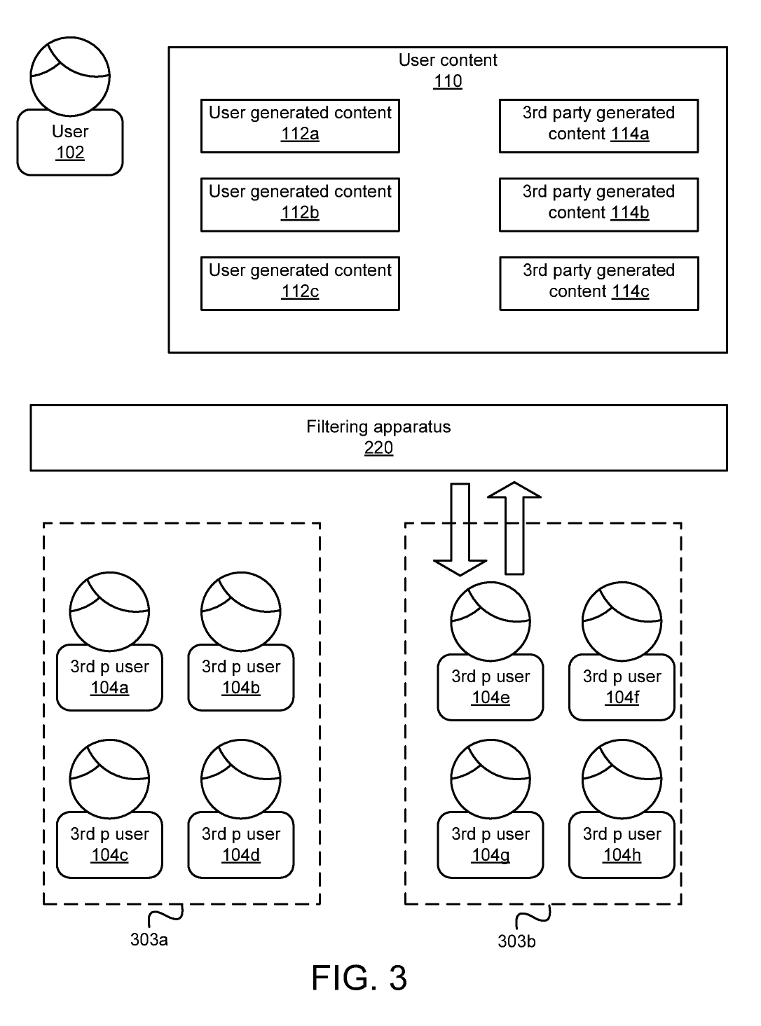

FIG. 3 shows one embodiment of how a filtering apparatus 220 may filter third-party generated content 114 for one or more third-party users 104a-h. In one embodiment, third-party users 104a-h transmits a request to view third-party generated content 114 for the user 102. A third-party user 104a-h sending such a request (in FIG. 3, third-party user 104e) is referred to as the requesting third party user 104e. The filtering apparatus 220 may receive, from the requesting third-party user 104e, a request to view third-party generated content 114a-c.

The third-party users 104a-h may be organized into one or more groups 303a-b. Groups 303a-b are collections of one or more entities. An entity is a group 303a-b, or a third-party user 104a-h. Thus, a group 303a-b may be a collection of third-party users 104a-h, a collection of groups 303a-b, or collection of groups 303a-b and third-party users 104a-h. The user 102 may define membership in the groups 303a-b.

In certain embodiments, the user 102 also sets one or more group permissions for the groups 303a-b. Group permissions are rules that define what user content 110 the third-party users 104a-h may access. In certain embodiments, the group permissions define access by third-party users 104a-h to the third party generated content 114a-c. The user 102 may set the group permissions for the groups 303a-b.

The group permissions may include a variety of rules. For example, for group 303a (which may be referred to in this example as the first group) the group permissions may include a first rule that specifies one or more entities with access to third-party generated content 114a-c created by third-party users (in this case third-party users 104a-d) that are members of the first group 303a. Thus, the rule may specify that the group 303b has access to third-party generated content 114a-c created by members of the group 303a.

The group permissions may also specify one or more entities that do not have access to third-party generated content 114a-c created by third-party users 104 that are members of the first group. Thus, for example, a second rule may specify that the group 303b does not have access to third-party generated content 114a-c created by members of the group 303a. Specifying that a group 303 has access, or does not have access, to particular third-party generated content 114a-c may mean that third-party users 104 who are members of the group 303 have or do not have the access given to their group 303.

In certain embodiments, a requesting third-party user 104e is given access to the third-party generated content 114a-c created by third-party users 104 within each group of which the requesting third-party user 104e is a member. In the example of FIG. 3, this may mean that the requesting third-party user 104e has access to the third-party generated content 114a-c created by third-party users 104e-h.

The user 102 may also set individual permissions. Individual permissions are rules that define access privileges of a particular third-party user 104 to the third-party generated content 114a-c. Thus, the user 102 may define a set of individual permissions for the third-party user 104a.

In certain embodiments, the filtering apparatus 220, after receiving a request to view third-party generated content 114a-c from a requesting third party user 104e, determines one or more group permissions set by the user 102 for one or more groups 303a-b that are applicable to the request. As noted above, group permissions define access to the third-party generated content 114a-c.

The filtering apparatus 220 may filter the third-party generated content 114a-c according to the one or more group permissions such that the third-party generated content 114 is filtered prior to presentation to the requesting third party user 104e in response to the request.

For example, the group 303a may be a group called “friends.” The group 303b may be a group called “co-workers.” The user 102 may set a group permission for the co-workers group 303b which states that members of the group 303b cannot see third-party generated content 114a-c generated by members of the friends group 303a. In this example, third-party generated content 114b was generated by a member of the friends group 303a. When the requesting third-party user 104e sends the request to view user content 110, the filtering apparatus 220 may determine the group permissions that apply to the co-workers group 303b, determine which group permissions are applicable to the requesting third-party user 104e, and filter the third-party generated content 114 according to the applicable group permissions. As a result, the requesting third-party user 104e does not receive the third-party generated content 114b in response to his request, as this third-party generated content 114b is filtered in accordance with the applicable group permissions.

The filtering apparatus 220 may also determine one or more individual permissions defining access to the third-party generated content 114a-c that are applicable to the request. The filtering apparatus 220 may filter the third-party generated content 114a-c according to the group permissions and the individual permissions. To continue with the example above, third-party user 104h may have created third-party generated content 114a. The user 102 may have assigned an individual permission to requesting third-party user 104e which specifies that requesting third-party user 104e cannot see third-party generated content 114b generated by third-party user 104a. The group permissions may not prevent the requesting third-party user 104e from seeing the third-party generated content 114a. However, the third-party generated content 114a will be filtered according to the individual permissions, while the third-party generated content 114b is filtered according to the group permissions.

The filtering apparatus 220 may have to determine the precedence of group permissions and individual permissions. In certain instances, a requesting third-party user 104e may belong to multiple groups with conflicting group permissions. The requesting third-party user 104e may also have individual permissions that conflict with group permissions. In certain embodiments, individual permissions take precedence over group permissions. In certain embodiments, where group permissions conflict, the most restrictive set of group permissions is applied for the requesting third-party user 104e. In these embodiments, if the group permissions of one group 303 to which the requesting third-party user 104e belongs allows the requesting third-party user 104e to see a particular piece of third-party generated content 114, but the group permissions of another group 303 to which the requesting third-party user 104e belongs does not allow the requesting third-party user 104e to see that same piece of third-party generated content 114, the piece of third-party generated content 114 will be filtered.

In certain embodiments, this filtering is hidden from the requesting third-party user 104e such that the requesting third-party user 104e is not aware that he or she does not have access to all of the third-party generated content 114.

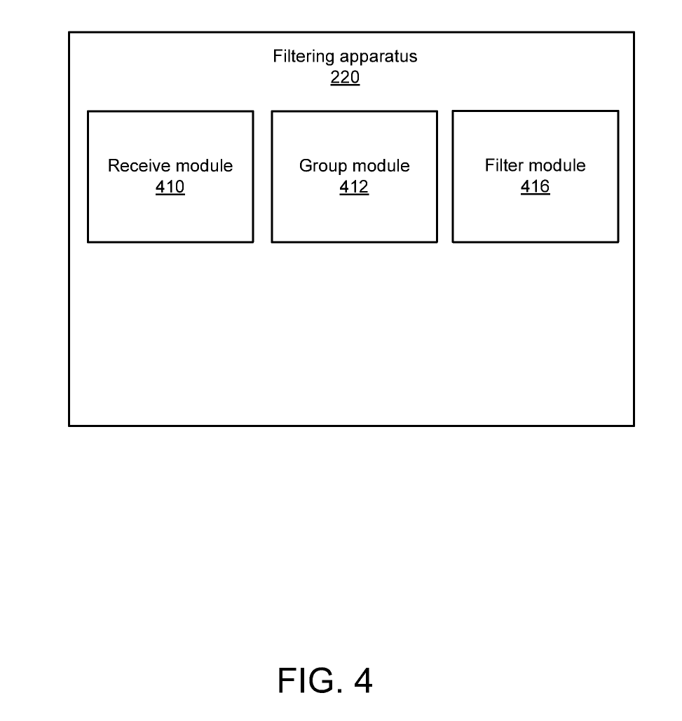

FIG. 4 shows one embodiment of a filtering apparatus 220. The filtering apparatus 220 may include a receive module 410, a group module 412, and a filter module 416. The filtering apparatus 220 may be realized as software executing on a computing device, as a hardware component, or a combination thereof. The filtering apparatus 220 may include more or fewer modules than those shown.

The receive module 410 may be configured to receive, from the requesting third-party user 104e, a request to view third-party generated content 114 that has been created by the third-party users 104 of the social network 210. The request may be generated by a client 204 and sent over a network to a server 202 that implements the filtering apparatus 220.

The group module 412 may determine the group permissions set by the user 102 for one or more groups 303. The group permissions define access to third-party generated content 114. The group module 412 may determine one or more group permissions for one or more groups 303 that are associated with third-party generated content 114 that is responsive to the request. In certain embodiments, the group module 412 takes the group permissions of the group 303 to which the requesting third-party user 104e belongs and determine that those group permissions are associated with the request. The group module 412 may select group permissions from the groups 303 to which the third party user 104 who created requested items of third-party generated content 114a-c belongs.

The filtering apparatus 220 may also include a filter module 416. The filter module 416 may filter the third-party generated content 114 according to the group permissions selected by the group module 412 such that the third-party generated content 114 is filtered prior to presentation to the requesting third-party user 104e in response to the request. The requesting third-party user 104e may be presented with only a subset of the third-party generated content 114 as a result of the filter module 416. As noted above, where multiple, conflicting group permissions are applicable to the request, the filter module 416 may apply the most restrictive set of group permissions to the third-party generated content 114.

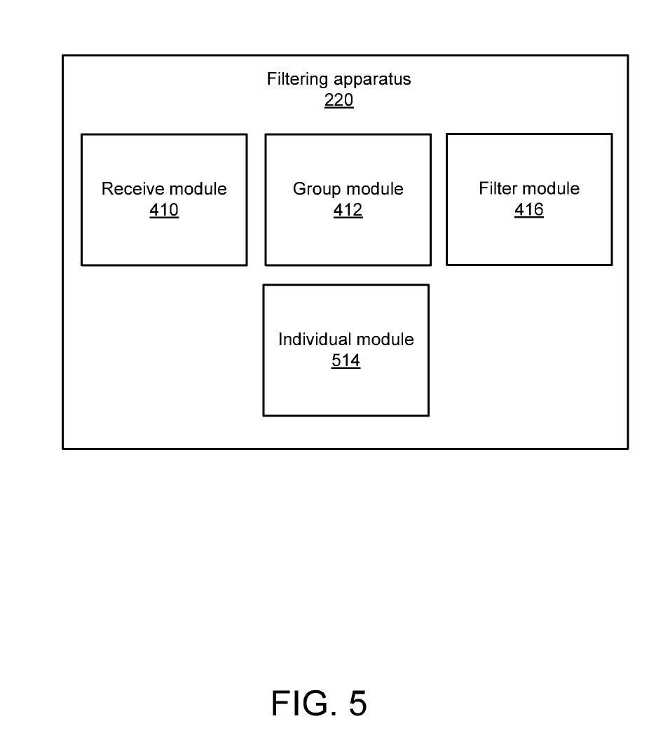

FIG. 5 shows an embodiment of the filtering apparatus 220 which also includes an individual module 514. In certain embodiments, the individual apparatus determines one or more individual permissions that define access to third-party generated content 114 that are set for the requesting third-party user 104e by the user 102. For example, the user 102 may specify that the requesting third-party user 104e may not see third-party generated content 114 created by the third-party user 104a.

In such embodiments, the filter module 416 may be further configured to filter the third-party generated content 114 according to both the group permissions and the individual permissions. The filter module 416 may give preference to individual permissions over group permissions. Thus, in the event that there is a conflict between the group permissions and the individual permissions, the individual permissions are applied instead of the group permissions.

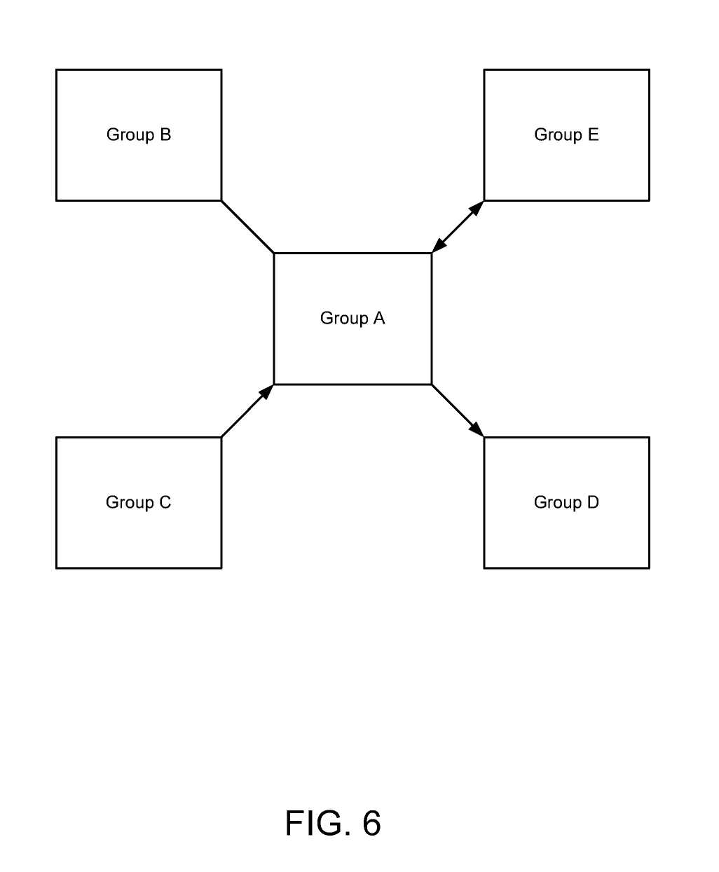

FIG. 6 shows one embodiment of how group permissions may be implemented. FIG. 6 shows five groups labeled Groups A-D. In certain embodiments, these group permissions are set by the user 102. In other embodiments, the group permissions may be set automatically by the filtering apparatus 220. In certain embodiments, the filtering apparatus 220 sets defaults that the user 102 can adjust.

In the example of FIG. 6, the group permissions specify that third-party users 104 who are members of Group A can access third-party generated content 114 created by members of Group E, and vice versa. The group permissions may be set by the user 102 when setting up Group A, when setting up Group E, or some combination thereof. The group permissions in FIG. 6 also specify that Group A can access third-party generated content 114 created by third-party users 104 who are members of Group D, but that third-party users 104 who are members of Group D cannot access third-party generated content 114 created by third-party users 104 who are members of Group A.

As to Group C, the group permissions specify that third-party users 104 who are members of Group A cannot see third-party generated content 114 created by third-party users 104 who are members of Group C, but that members of Group C can see third-party generated content 114 created by third-party users 104 who are members of Group A. As to Group B, the group permissions specify that the third-party users 104 who are members of the respective Groups B and A cannot see third-party generated content 114 created by members of the other group 303.

Thus, the group permissions may specify a wide range of visibility options between groups 303. In certain embodiments, the group permissions apply to all third-party generated content 114. In other embodiments, the user 102 may more granularly apply group permissions to certain types of third-party generated content 114. For example, the user 102 may specify that members of Group A can access comments created by members of Group E, but cannot access photos created by members of Group E.

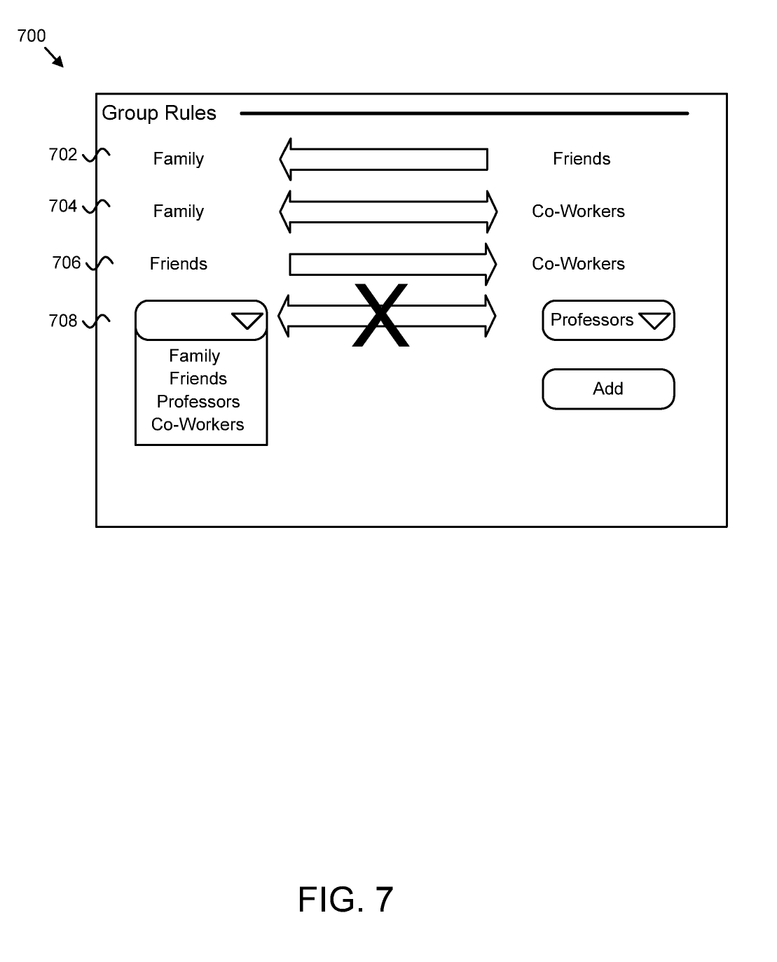

FIG. 7 shows one example of a user interface 700 by which a user 102 may set group permissions. The user 102 may create groups 303 by adding third-party users 104 to different groups 303. The user 102 may also give the groups descriptive names, such as those shown in FIG. 7. In the depicted embodiment, the user 102 may select a group 303 on the left side and a group 303 on the right side. The user 102 may then select a graphical element to represent group permissions. Various examples of possible relationships between groups 303 are shown as entries 702, 704, 706, and 708.

For example, the user 102 may select the group 303 “family” on the left side, and the group 303 “friends” on the right side for entry 702. The user 102 may also select a graphical element, such as the arrow pointing from friends to family, to represent the group permission. The arrow pointing from the friends group 303 to the family group 303 may indicate that the group permissions allow members of the friends group 303 to see third-party generated content 114 created by members of the family group 303, but that members of the family group 303 cannot see third-party generated content 114 created by the friends group 303.

Similar group permissions may be defined for other groups 303. The user 102 may create the entry 704 which shows that members of the family group 303 may see third-party generated content 114 created by members of the co-workers group 303, and vice-versa. Entry 706 specifies that members of the friends group 303 can see third-party generated content 114 created by members of the co-workers group 303, but members of the co-workers group 303 cannot see third-party generated content 114 created by members of the friends group 303. Entry 708 specifies that members of the group 303 to be selected by the user 102 cannot see third-party generated content 114 created by members of the professors group 303, and vice versa.

In certain embodiments, the user 102 can select existing groups 303 from a drop-down menu to create the entries 702-708. Other approaches for accepting and responding to user input can also be used. The interface 700 may also provide a button or other input tool to allow the user 102 to indicate that she wishes to create a new entry.

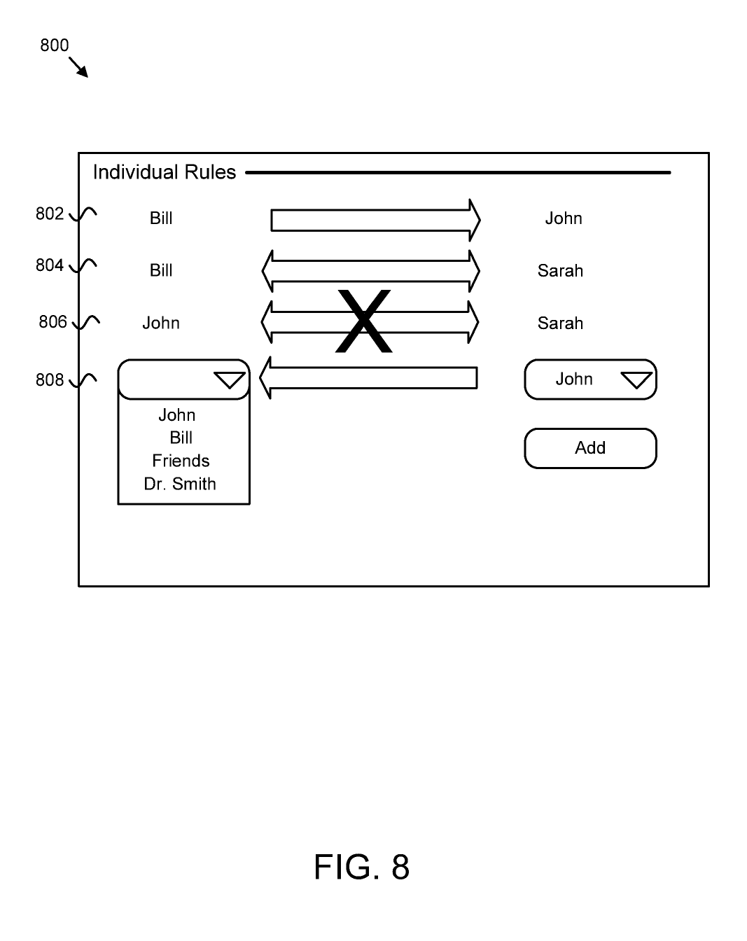

FIG. 8 shows one embodiment of a user interface 800 allowing the user 102 to set individual permissions. The interface 800 may operate in a manner very similar to that described above in connection with the interface 700 for groups. Particularly, the user 102 may create entries 802-808 specifying the individual permissions between particular third-party users 104 and other entities.

For example, the user 102 may create an entry 802 which specifies that the third-party user 104 named “Bill” can see third-party generated content 114 created by John. While FIG. 8 shows entries 802-808 specifying individual permissions between third-party users 104 who are individuals, the user 102 may define an entry specifying an individual permission between an individual and a group 303. For example, the user 102 may create an entry 808 specifying that “John” cannot see third-party generated content 114 created by members of the friends group 303.

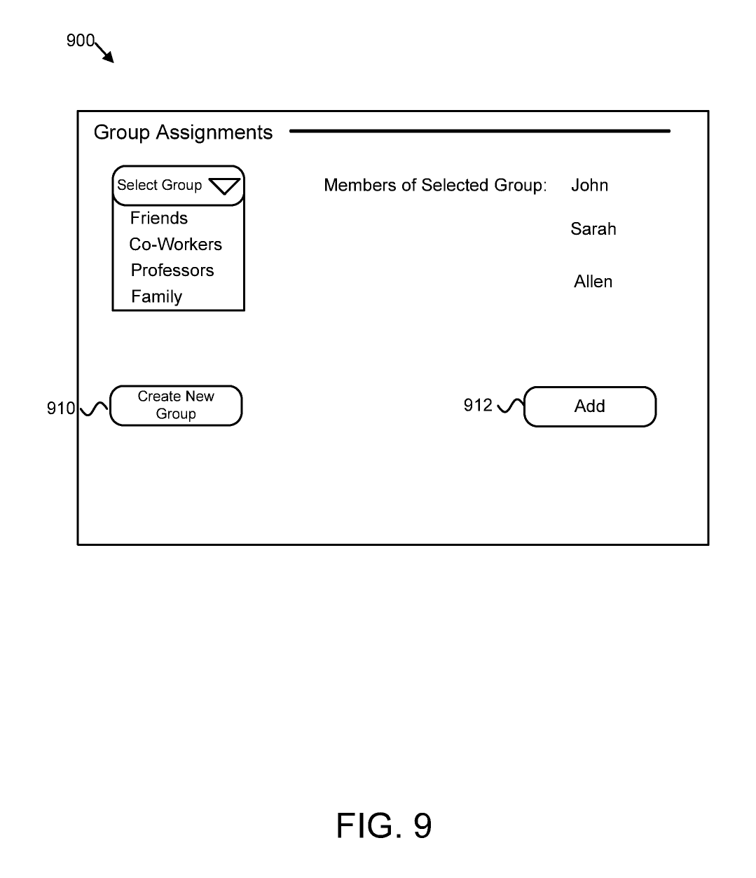

FIG. 9 shows one embodiment of an interface 900 for defining membership of a group. The user 102 may use the interface 900 to specify which third-party users 104 belong to which groups 303. As noted above, in certain embodiments, the user 102 may make one group 303 a member of another group 303. For example, the user 102 may define a group 303 named “Sales Team,” and make the sales team group 303 a member of a group 303 named “Co-workers.”

In certain embodiments, the interface 900 provides components (such as buttons, drop-down bars, or others), such as component 910, that allow the user 102 to create new groups. The interface 900 may also provide a component 912 to allow the user 102 to add additional third-party users 104 and groups 303 to a particular group 303.

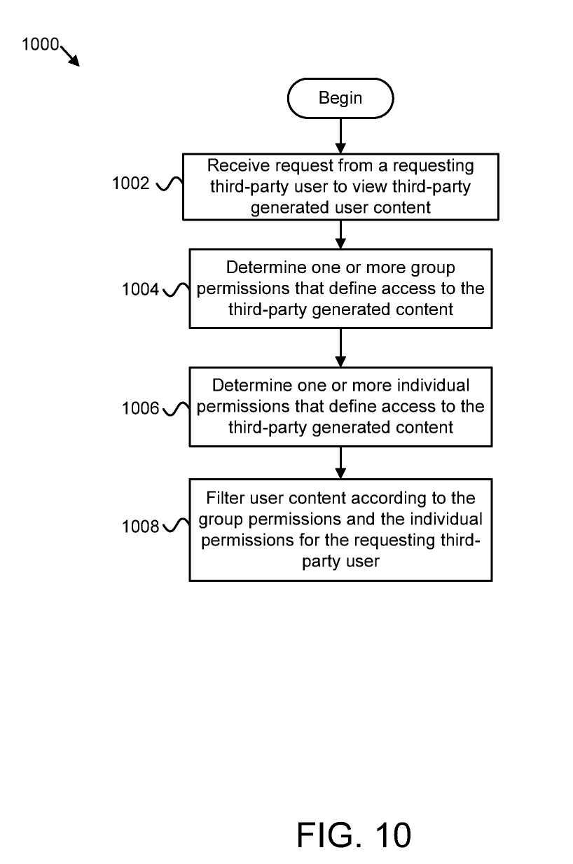

FIG. 10 shows one embodiment, of a method 1000 for filtering third-party generated content 114 in a social network 210. In one embodiment, the method 1000 begins with receiving 1002, from a requesting third-party user 104e, a request to view third-party generated content 114 in the social network 210. The method 1000 also may involve determining 1004 one or more group permissions set by the user 102 for one or more groups 303, which group permissions define access to the third-party generated content 114.

The method 1000 may further involve determining 1006 one or more individual permissions that define access to the third-party generated content 114. The method 1000 may also involve filtering 1008 the third-party generated content 114 according to the group permissions and the individual permissions for the requesting third-party user 104e prior to presentation of the third-party generated content 114 to the requesting third-party user 104e.

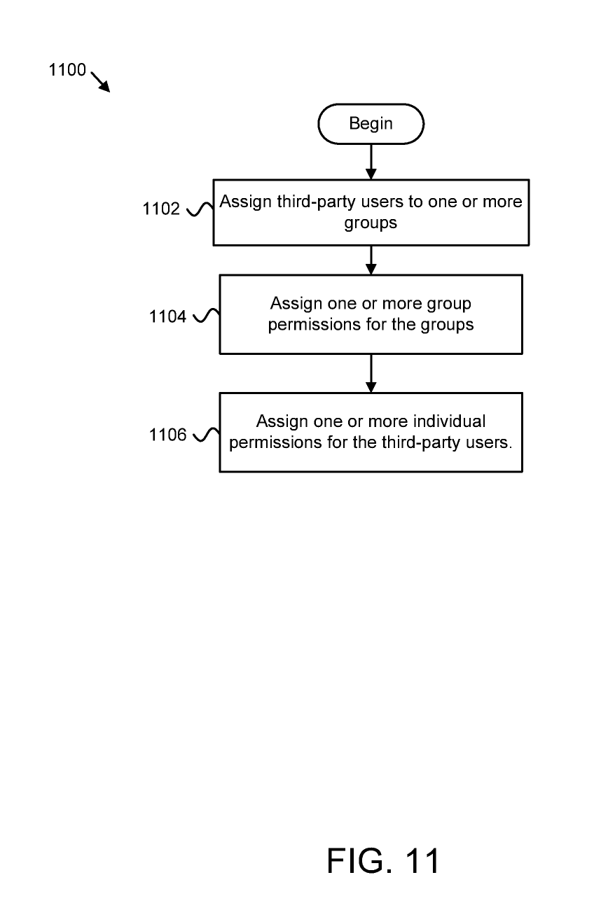

FIG. 11 shows one embodiment of a method 1100 for setting filters for third-party generated content 114 in a social network 210. In certain embodiments, the user 102 performs the steps of the method 1100 using a computer that is a client 204 in communication with a server 202 implementing the social network 210. In certain embodiments, the filtering apparatus 220 presents an interface 900 to the user 102 allowing the user 102 to make the various assignments discussed below.

In one embodiment, the method 1100 begins with assigning 1102 third-party users 104 (or groups of third-party users 104) of a social network 210 to one or more groups 303. The method 1100 may also involve assigning 1104 one or more group permissions for the one or more groups 303. In certain embodiments, the one or more group permissions define access of group members to third-party generated content 114. The method 1100 may also involve assigning 1106 one or more individual permissions for third-party users 104. As noted above, the individual permissions may take precedence over the group permissions. That individual permissions take precedence over group permissions means that, when a group permission and individual permission conflict, the individual permission is applied.

Embodiments of the present invention may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes,” “has,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer program product to filter third-party generated content in a social network, the computer program product configured to:
receive, from a requesting third-party user, a request to view third-party generated content that is generated by one or more third-party users of a social network;
determine one or more group permissions set by a user for one or more groups, the one or more group permissions defining access to the third-party generated content; and
filter the third-party generated content according to the one or more group permissions such that the third-party generated content is filtered prior to presentation of the third-party generated content to the requesting third-party user in response to the request.

2. The computer program product of claim 1, further configured to determine one or more individual permissions defining access to the third-party generated content, wherein the individual permissions are set for the requesting third-party user by the user.

3. The computer program product of claim 2, further configured to filter the third-party generated content according to the one or more group permissions and according to the one or more individual permissions.

4. The computer program product of claim 2, wherein filtering the third-party generated content comprises determining a precedence of the one or more group permissions and the one or more individual permissions.

5. The computer program product of claim 4, wherein the one or more individual permissions take precedence over the one or more group permissions.

6. The computer program product of claim 4, wherein filtering the third-party generated content according to the one or more group permissions comprises applying a most restrictive set of group permissions in response to the requesting third-party user being a member of a plurality of groups.

7. The computer program product of claim 1, wherein the one or more group permissions for a first group comprise at least one of:
a first rule specifying one or more entities with access to third-party generated content created by third-party users that are members of the first group; and
a second rule specifying one or more entities that do not have access to third-party generated content created by third-party users that are members of the first group.

8. The computer program product of claim 1, wherein the requesting third-party user is given access to third-party generated content created by third-party users within each group of which the requesting third-party user is a member.

9. The computer program product of claim 1, wherein the filtering is hidden from the requesting third-party user.

10. An apparatus to filter third-party generated content in a social network, the apparatus comprising:
a receive module that receives, from a requesting third-party user, a request to view third-party generated content that is generated by one or more third-party users of a social network;
a group module that determines one or more group permissions set by a user for one or more groups, the one or more group permissions defining access to the third-party generated content; and a filter module that filters the third-party generated content according to the one or more group permissions such that the third-party generated content is filtered prior to presentation of the third-party generated content to the requesting third-party user in response to the request.

11. The apparatus of claim 10, further comprising an individual module that determines one or more individual permissions defining access to the third-party generated content, wherein the individual permissions are set for the requesting third-party user by the user.

12. The apparatus of claim 11, wherein the filter module filters the third-party generated content according to the one or more group permissions and according to the one or more individual permissions.

13. The apparatus of claim 12, wherein the one or more individual permissions take precedence over the one or more group permissions.

14. The apparatus of claim 12, wherein filtering the third-party content according to the one or more group permissions comprises applying a most restrictive set of group permissions in response to the requesting third-party user being a member of a plurality of groups.

15. The apparatus of claim 11, wherein the apparatus is implemented in a server.

16. The apparatus of claim 15 wherein the requesting third-party user sends the request from a client communicatively connected to the server.

17. A method for filtering third-party generated content in a social network, the method comprising:
receiving, from a requesting third-party user, a request to view third-party generated content that is generated by one or more third-party users of a social network;
determining one or more group permissions set by a user for one or more groups, the one or more group permissions defining access to the third-party generated content; and
filtering the third-party generated content according to the one or more group permissions such that the third-party generated content is filtered prior to presentation of the third-party generated content to the requesting third-party user in response to the request.

18. The method of claim 17, further comprising determining one or more individual permissions defining access to the third-party generated content, wherein the individual permissions are set for the requesting third-party user by the user.

19. The method of claim 18, further comprising filtering the third-party generated content according to the one or more group permissions and according to the one or more individual permissions.

20. The method of claim 18, wherein filtering the third-party generated content comprises determining a precedence of the one or more group permissions and the one or more individual permissions.

21. The method of claim 20, wherein the one or more individual permissions take precedence over the one or more group permissions.

22. The method of claim 20, wherein filtering the third-party generated content according to the one or more group permissions comprises applying a most restrictive set of group permissions in response to the requesting third-party user being a member of a plurality of groups.

23. The method of claim 17, wherein the requesting third-party user is given access to third-party generated content created by third-party users within each group of which the requesting third-party user is a member.

24. The method of claim 17, wherein the filtering is hidden from the requesting third-party user.

25. A method for setting filters for third-party generated content in a social network, the method comprising:
assigning third-party users of a social network to one or more groups;
assigning one or more group permissions for the one or more groups, the one or more group permissions defining access of group members to third-party generated content;
assigning one or more individual permissions for one or more of the third-party users, the one or more individual permissions defining access of individual third-party users to the third-party generated content, and wherein the one or more individual permissions take precedence over the one or more group permissions.
